(19) United States
(12) Patent Application Publication
(10) Pub. No.: US 2013/0277146 A1
(43) Pub. Date: Oct. 24, 2013

(54) CONVERGENCE SOUND-ABSORBING MATERIAL AND METHOD OF FABRICATING THE SAME

(71) Applicants: HYUNDAI MOTOR COMPANY, Seoul (KR); KIA MOTORS CORPORATION, Seoul (KR); DAEHAN SOLUTION CO., LTD., Incheon (KR); YOUNGSEUNG CO., LTD., Asan (KR)

(72) Inventors: Jung Wook Lee, Seoul (KR); Dong Uk Lee, Seoul (KR); Jin Ho Hwang, Seoul (KR); Hoe Hyun Kwon, Seoul (KR); Jung Hoi Choi, Asan (KR)

(73) Assignees: HYUNDAI MOTOR COMPANY, Seoul (KR); YOUNGSEUNG CO., LTD., Asan (KR); DAEHAN SOLUTION CO., LTD., Incheon (KR); KIA MOTORS CORPORATION, Seoul (KR)

(21) Appl. No.: 13/628,796

(22) Filed: Sep. 27, 2012

(30) Foreign Application Priority Data
Apr. 24, 2012 (KR) 10-2012-0042595

(51) Int. Cl. G10K 11/168; B32B 37/24

(52) U.S. Cl. 181/290; 156/62.2

(57) ABSTRACT

Disclosed is a convergence sound-absorbing material and a method of fabricating the same, and more particularly, a convergence sound-absorbing material and a method of fabricating the same in which an inexpensive eco-friendly recycled filler composed of polyurethane foam and a recycled thread or waste felt is used as a filler in an intermediate layer of the PET sound-absorbing material to provide remarkably reduced fabrication costs and excellent sound-absorbing performance. In addition the waste felt, which is typically discarded during a process of cutting the sound-absorbing material, is recycled for use in the filler.

### CROSS-REFERENCE TO RELATED APPLICATION

This application claims under 35 U.S.C. §119(a) the benefit of Korean Patent Application No. 10-2012-0042595 filed Apr. 24, 2012, the entire contents of which are incorporated herein by reference.

### BACKGROUND

(a) Technical Field

The present disclosure relates to a convergence sound-absorbing material having an intermediate layer of a polyethylene terephthalate (PET) sound-absorbing material, and a method for its fabrication. More particularly, it relates to a convergence sound-absorbing material having an intermediate layer of PET sound-absorbing material that includes a filler which contains a low-melting PET fiber, a regular PET fiber, and a chip foam.

(b) Background Art

During vehicle operation, external noise enters the vehicle through various routes. A frictional sound generated between a tire and the ground, a noise generated by a flow of a high-temperature and high-pressure combustion gas of an exhaust system, and an engine penetration noise generated in an engine and transferred through a vehicle body or air carry inside the vehicle to the passengers, degrading stillness of the vehicle.

To reduce the engine penetration noise, an engine cover or a hood insulator is generally used. However, such methods alone are capable of only limited reduction of the engine penetration noise.

In an attempt to further reduce engine penetration noise to desired levels, sound-absorbing materials have been mounted on the front, a left side, and the bottom of a vehicle. For example, to block a noise generated in an engine compartment, a sound-absorbing material is installed in a dash panel which partitions the engine compartment and a vehicle compartment. Further, and to cut off a noise introduced through a side of the vehicle body, a sound-absorbing material is attached to a side panel.

As sound-absorbing materials, a glass fiber, a urethane foam, a mixed-thread felt, a general polyethylene terephthalate (PET) fiber, and the like have been used. In view of increasing standards of various countries with respect to the use of materials that are more eco-friendly and which may be recycled, a fiber felt based on thermoplastic resin such as polypropylene (PP), polyurethane foam, and a PET felt are widely used as materials for improving sound absorption and thermal insulation capabilities in vehicles.

As to a sound-absorbing material containing a PET resin, Korean Patent Registration No. 10-0893690 suggests a sound absorbing/insulating vehicle interior material in which a polyurethane sheet fabricated by compression-molding a waste polyurethane scrap and a PET sheet on an outer side of the polyurethane sheet are deposited and coupled to each other through thermal bonding. However, the recycling of the waste felt or a recycled mixed-thread is considered slightly insufficient to serve as an eco-friendly sound-absorbing material. In addition, waste polyurethane foam is compressed to fill a gap by using a one-part adhesive which negatively affects sound-absorbing rate and utilizes volatile organic compounds (VOC). One-part adhesives are generally known as those which harden via a chemical reaction with an external energy source (e.g., radiation, heat, moisture), as opposed to a multi-part adhesive which harden by mixing the multiple components which chemically react.

Korean Patent Application Publication No. 2007-0046019 proposes a PET sound-absorbing material using a mixed-thread felt in which a sound-absorbing material basal layer is composed of a high-melting PET fiber, a low-melting fiber as a binder, and a mixed-thread fiber. However, when compared to a sound-absorbing material containing polyurethane foam, the PET sound-absorbing material has a poor NVH capability (sound absorbing/insulating capability).

For example, the polyurethane foam or PET felt has an air hole therein through which a sound may be introduced, such that a sound-absorbing material using the polyurethane foam or PET felt reduces a noise by causing sounds introduced through the air hole to collide and be absorbed in the material. When the sounds are absorbed and thus reduced, the degree of noise reduction depends on various acoustic physical properties of the materials. Generally, acoustic performance is adjusted by simply controlling thickness or weight of the material.

Meanwhile, to improve Noise, Vibration, Harness (NVH) capabilities of a vehicle according to acoustic characteristics, midsize and large luxury vehicles mainly use high-weight and high thickness sound-absorbing material. However, when using the high-weight and high thickness sound-absorbing material, while the noise is reduced and the stillness of the vehicle is improved, the weight of the vehicle body increases resulting in decreased mileage.

Thus, there is a need to overcome the foregoing problems of the conventional sound-absorbing material, by providing an improved sound-absorbing material that is eco-friendly, recyclable, and cheap. In particular, there is a need for an improved sound-absorbing material that has reduced weight while still improving sound-absorbing capability.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art, and provides a convergence sound-absorbing material including an upper layer, a lower layer and an intermediate layer. In particular, a convergence sound-absorbing material is provided wherein the upper layer and the lower layer include sound-absorbing felts which contain a low-melting PET fiber and a regular PET fiber, and wherein the intermediate layer includes a filler which contains a low-melting PET fiber, a regular PET fiber, and chip foam. The terms “low-melt PET fiber” and “regular PET fiber” are terms commonly used in the auto industry and other fabric industries and, thus, their meanings are in accordance with their commonly understood meanings. Generally, the low-melt PET fibers will have a melting point lower than the regular PET fiber. Regular PET fibers commonly refer to conventional or general PET, which is often used as PET staple fiber in the auto industry and other fabric industries.

The present invention also provides a convergence sound-absorbing material which satisfies both fabricating cost and sound-absorbing requirements at the same time.

In one aspect, the present invention provides a convergence sound-absorbing material, in which upper layers and lower layers are sound-absorbing felts which contain a low-melting (LM) point polyethylene terephthalate (PET) fiber and a regular PET fiber, and an intermediate layer is a filler which contains an LM point PET fiber, a regular PET fiber, and chip foam.

In another aspect, the present invention provides method of fabricating a convergence sound-absorbing material, the method comprising melting and mixing a low-melting (LM) point polyethylene terephthalate (PET) fiber and a regular PET fiber to fabricate a sound-absorbing material, melting and mixing an LM point PET fiber, a regular PET fiber, and chip foam to fabricate a filler, laying the sound-absorbing felt in piles to form upper felt layers and lower felt layers, and sequentially laying the lower felt layers, the filler, and the upper felt layers in piles, and applying heat and pressure thereto to fabricate a convergence sound-absorbing material.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to a certain exemplary embodiment thereof illustrated the accompanying drawings which are given hereinbelow by way of illustration only, and thus are not limitative of the present invention, and wherein:

FIG. 1 shows cross-sectional structures of sound-absorbing materials fabricated by Embodiments 1 and 2 of the present invention and Comparison Example 1;

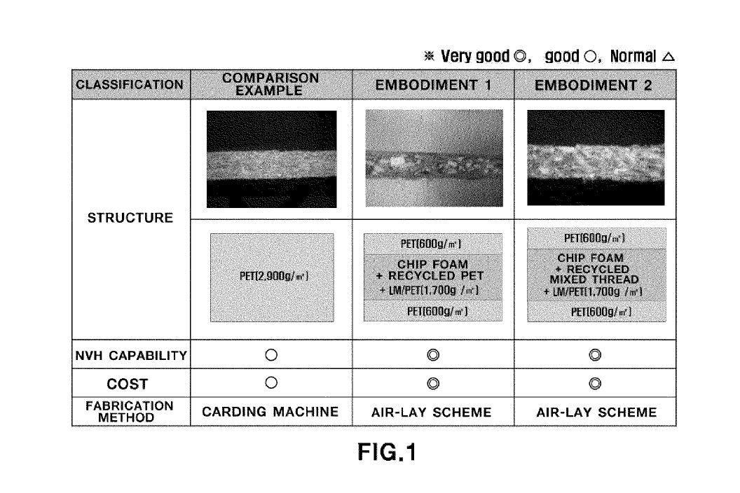

FIG. 2 is a flowchart schematically illustrating a process of fabricating a sound-absorbing material according to an embodiment of the present invention;

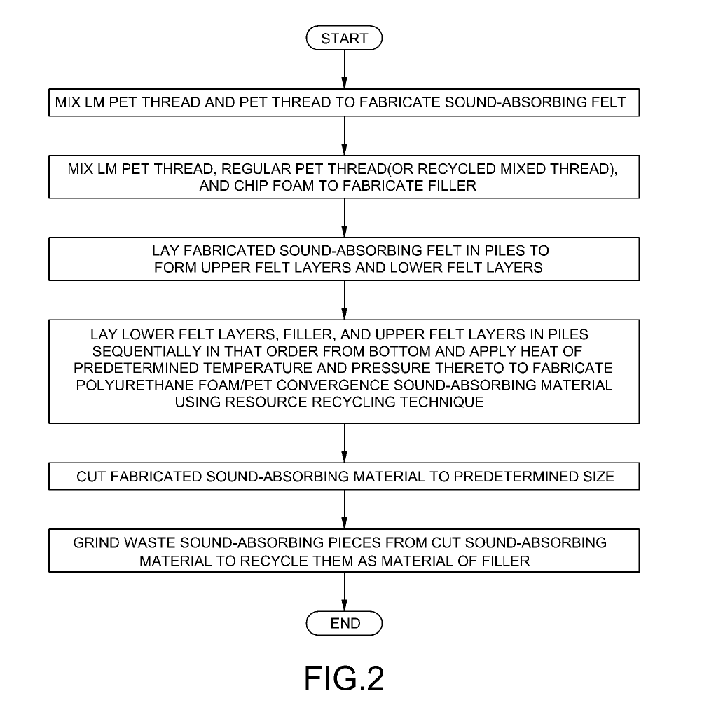

FIG. 3 is a diagram schematically illustrating a process of fabricating a process of fabricating a sound-absorbing material according to an embodiment of the present invention; and

FIG. 4 is a graph showing results of measurements of sound-absorbing rates of sound-absorbing materials fabricated by Embodiments 1 and 2 of the present invention and Comparison Example 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings to allow those of ordinary skill in the art to easily carry out the present invention. While the invention will be described in conjunction with the exemplary embodiments, it will be understood that present description is not intended to limit the invention to the exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in more detail with an exemplary embodiment.

The present invention provides a convergence sound-absorbing material in which an upper layer and a lower layer are sound-absorbing felts which contain a low-melting PET fiber and a regular PET fiber, and an intermediate layer is a filler which contains a low-melting PET fiber, a regular PET fiber, and chip foam.

PET is polyethylene terephthalate, which is commonly referred to as polyester or polyester used as a fabricating material for a PET bottle. Polyester, which currently occupies about 65% of total synthetic fiber production, is widely used in our daily lives not only in sound-absorbing materials but also can be found in clothes, plastic containers, and various household items. Herein, a low-melting (LM) PET fiber is a fiber fabricated by spinning an LM PET resin, and the regular PET fiber is a fiber fabricated by spinning a regular PET resin.

The regular PET fiber has better vibration qualities when it is fabricated with higher fineness, thus resulting in a better sound-absorbing performance. According to various embodiments, it is preferred to use a PET fiber having a fineness of about 6-7 denier (D). When the regular PET fiber has a fineness less than 6 D, then production speed is lowered, resulting in decreased productivity. On the other hand, when the PET fiber has a fineness larger than 7 D, then sound-absorbing performance may be degraded.

According to various embodiments, the sound-absorbing felt is preferably formed of an LM PET fiber and a regular PET fiber at a weight ratio of about (25-45):(55-75). If the LM PET fiber is less than 25 wt %, then binding capacity of the PET felt is reduced. On the other hand, if the LM PET fiber is larger than 45 wt %, then the PET felt may become rigid, which can degrade sound-absorbing rate.

According to a preferred embodiment of the present invention, the filler may comprise a mixture of an LM PET fiber, a regular PET fiber, and chip foam. In particular, the filler may comprise the LM PET fiber, regular PET fiber and the chip foam at a weight ratio of about (25-45):(15-35):(30-50). According to various embodiments, the chip foam is polyurethane foam, which is generally a foamed product obtained by mixing a foaming agent, a contact agent, a stabilizer, a flame retardant, etc., with main components of polyol and isocyanate. The chip foam is widely used as a high-performance insulating material throughout various industries, for example, in clothing, construction, electronic appliances, vehicle sheets, and so forth. According to various embodiments of the present invention, the chip foam may comprise a ground polyurethane foam. Unlike a conventional mold foam, such a chip foam that comprises a ground polyurethane foam does not require use of an adhesive, and it may be flexibly used by adjusting its physical shape.

Foamed resins, such as polyurethane foam, may significantly improve the elasticity and sound-absorbing capability of a sound-absorbing material. According to various embodiments, the waste felt or recycled mixed thread may be used in place of the regular PET fiber. As a result, in contrast with typical sound-absorbing materials that are generally fabricated at a high cost, a filler composed of inexpensive recycled materials such as the waste felt or polyurethane foam remarkably reduces the fabricating cost of the sound-absorbing material.

According to an exemplary embodiment of the present invention, the convergence sound-absorbing material preferably includes felt layers composed of upper layers and lower layers which are laid in piles with a weight of each respective layer being about 200-800 g/m², and also includes a filler which is an intermediate layer with a weight of about 1500-1900 g/m². Most preferably, the upper layers and the lower layers may each be provided with a weight of about 300-600 g/m². The present invention further provides a method for fabricating a convergence sound-absorbing material which includes the steps of:

fabricating a sound-absorbing felt by melting a low-melting point PET fiber and a regular PET fiber;

fabricating a filler by melting a low-melting point PET fiber, a regular PET fiber, and chip foam;

forming upper felt layers and lower left layers by laying the sound-absorbing felt in piles; and

fabricating the convergence sound-absorbing material by sequentially laying the upper felt layers, the filler, and the upper felt layers in that order and applying heat and pressure thereto.

According to an exemplary embodiment of the present invention, the sound-absorbing felt is preferably formed by mixing the low-melting point PET fiber and the regular PET fiber at a weight ratio of about (25-45):(55-75). To maintain an optimal binding force, most preferably, the low-melting point PET fiber and the regular PET fiber are at a weight ratio of about 35:65.

The filler may be formed by mixing the low-melting point PET fiber, the regular PET fiber, and the chip foam at a weight ratio of about (25-45):(15-35):(30-50). Most preferably, the low-melting point PET fiber, the regular PET fiber, and the chip foam are mixed at a weight ratio of about 35:25:40.

According to an exemplary embodiment of the present invention, the convergence sound-absorbing material includes upper layers and lower layers each with a weight of about 200-800 g/m², and also includes an intermediate layer with a weight of about 1500-1900 g/m². In each fabrication step, a melting temperature and heat applied are at about 150-180° C. Most preferably, in a temperature range of about 160-170° C., the low-melting point PET fiber is melted to bind the regular PET fiber with the chip foam. The melting temperature is such that heat and pressure of a temperature capable of melting a low-melting point PET thread having the lowest melting point are applied to fabricate a sound-absorbing material in which the upper and lower felt layers and the filler are bound as one piece.

According to various embodiments, the method of fabricating the convergence sound-absorbing material may further include a step of grinding waste sound-absorbing pieces from the sound-absorbing material which is subsequently cut to various sizes, and recycling the ground waste pieces as a regular PET fiber substitute for the filler.

When compared to a conventional sound-absorbing material fabricated using only a low-melting point PET fiber and a regular PET fiber, the sound-absorbing material fabricated by the present method has a higher elastic restoring force and may be fabricated at a lower fabricating cost.

Hereinafter, the present invention will be described in more detail based on the following embodiments thereof, without being limited thereto.

### Embodiment 1

Unlike a conventional mold foam, without using an adhesive, polyurethane foam was ground to form chip foam with an optimal size merely through physical shape adjustment. Then, a low-melting (LM) PET thread, a regular PET thread, and the chip foam were mixed at a weight ratio of 35:25:40 and passed through processing by an opener, a super mixer, and an air raider, thus forming a filler. The LM PET thread and the regular PET thread were mixed at a weight ratio of 35:65, thus forming a sound-absorbing felt through processing by an opener, a super mixer, and an air raider. In this stage, the formed sound-absorbing felt was laid in piles to have a weight of 300-600 g/m², thus forming upper felt layers of the sound-absorbing material. Similarly, lower felt layers of the sound-absorbing material were also formed.

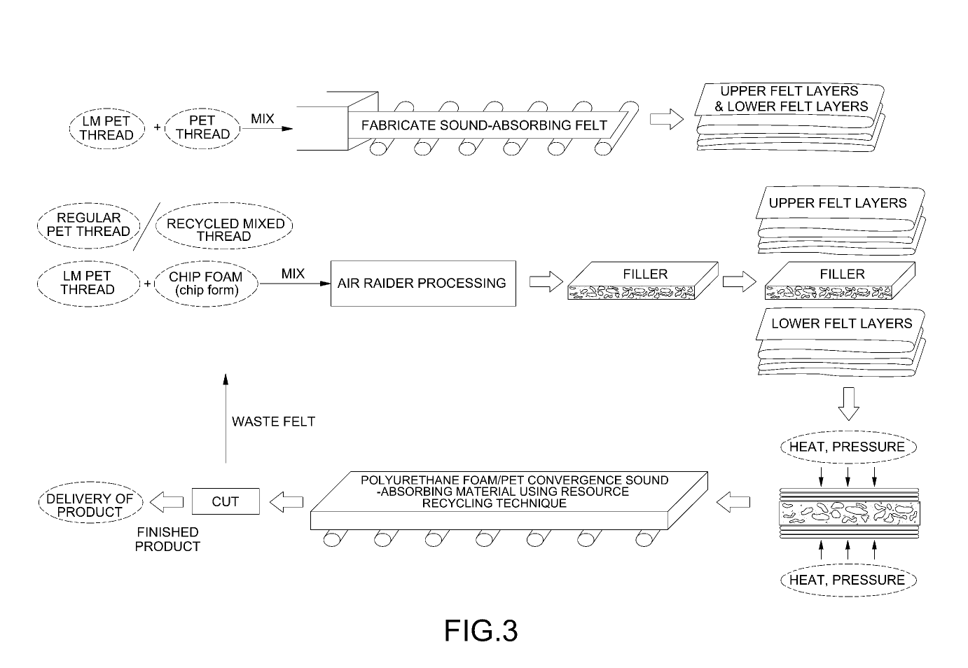

Once the upper felt layers, the filler, and the lower felt layers were all formed, as shown in FIG. 3, the lower felt layers having a weight of 600 g/m², the filler having a weight of 1700 g/m², and the upper felt layers having a weight of 600 g/m² were sequentially laid in layers in that order from the layered structure. Then, a predetermined pressure and heat of 160-170° C. were applied to fabricate a convergence sound-absorbing material.

### Embodiment 2

The same method as in Embodiment 1 was performed, except that the LM point PET thread, a recycled mixed-thread, and the chip foam were mixed at a weight ratio of 35:25:40 to fabricate a convergence sound-absorbing material.

### COMPARISON EXAMPLE 1

The same method as in Embodiment 1 was performed, except that a predetermined pressure and heat of 160-170° C. were applied to a PET thread of 100 wt % with a weight of 2900 g/m² to fabricate a PET sound-absorbing material.

### TEST EXAMPLE

An Alpha Cabin system of a reverberation room scaled-down model developed by Rieter of Switzerland was used to analyze the sound-absorbing capabilities of the sound-absorbing materials fabricated by Embodiment 1, Embodiment 2, and Comparison Example 1. This system performed measurement of up to 400-10 kHz, a common frequency interval of a vehicle sound-absorbing material, by using a sound-absorbing material as a test piece having a size of 1.2 m².

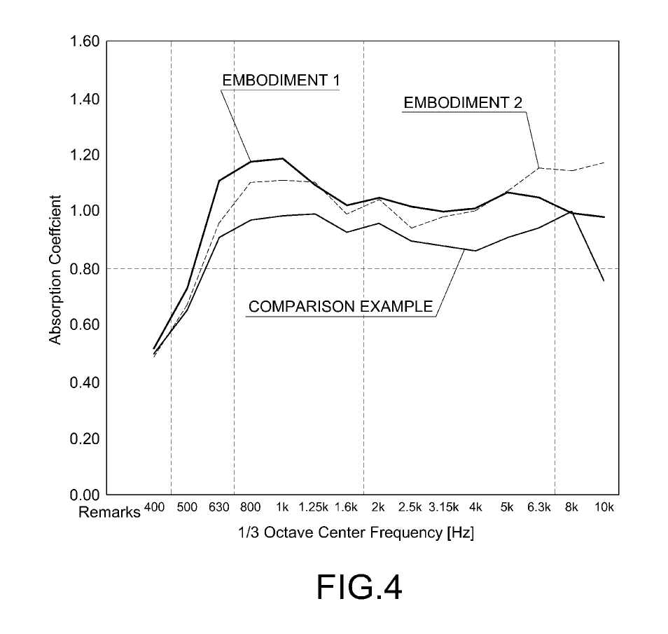

FIG. 4 shows results of comparison and analysis of the sound-absorbing capabilities of the sound-absorbing materials fabricated by Embodiment 1, Embodiment 2, and Comparison Example 1. As shown in FIG. 4, in Embodiment 1 and Embodiment 2, a sound-absorbing rate was measured as 0.7-1.2 in a frequency band of 400-10 kHz. As shown, Embodiment 1 and Embodiment 2 in which the filler contained the LM point PET thread, the recycled mixed thread, and the chip foam as an intermediate layer of the PET sound-absorbing material in accordance with the present invention, demonstrated superior sound-absorbing effects when compared to Comparison Example 1 in which the PET thread of 100 wt % was used.

According to the present invention, by filling an inexpensive eco-friendly recycled filler composed of polyurethane foam and a recycled thread or waste felt into an intermediate layer of the PET sound-absorbing material, a convergence sound-absorbing material having a remarkably reduced fabrication cost and excellent sound-absorbing performance when compared to a conventional sound-absorbing material can be fabricated.

In addition, the waste felt, which is generally discarded during a process of cutting the sound-absorbing material, is recycled as a filler. As a result, costs are further reduced.

While exemplary embodiments of the present invention has been described in detail, the protection scope of the present invention is not limited to the foregoing embodiments and it will be appreciated by those skilled in the art that various modifications and improvements using the basic concept of the present invention defined in the appended claims are also included in the protection scope of the present invention.

What is claimed is:

1. A convergence sound-absorbing material comprising:
upper and lower layers of sound-absorbing felts which contain a low-melting (LM) point polyethylene terephthalate (PET) fiber and a regular PET fiber; and
an intermediate layer disposed between the upper and lower layers, wherein the intermediate layer is a filler which contains an LM point PET fiber, a regular PET fiber, and a chip foam.

2. The convergence sound-absorbing material of claim 1, wherein the regular PET fiber has a fineness of about 6-7 denier.

3. The convergence sound-absorbing material of claim 1, wherein the sound-absorbing felts are formed by mixing the LM point PET fiber and the regular PET fiber at a weight ratio of about (25-45):(55-75).

4. The convergence sound-absorbing material of claim 1, wherein the filler is formed by mixing the LM point PET fiber, the regular PET fiber, and the chip foam at a weight ratio of about (25-45):(15-35):(30-50).

5. The convergence sound-absorbing material of claim 1, wherein the chip foam is polyurethane foam which does not include an adhesive.

6. The convergence sound-absorbing material of claim 1, wherein in the convergence sound-absorbing material, the upper layers and the lower layers each have a weight per area of about 200-800 g/m² and the intermediate layer has a weight per area of about 1500-1900 g/m².

7. A method of fabricating a convergence sound-absorbing material, the method comprising:
melting and mixing a low-melting (LM) point polyethylene terephthalate (PET) fiber and a regular PET fiber to fabricate a sound-absorbing material;
melting and mixing an LM point PET fiber, a regular PET fiber, and chip foam to fabricate a filler;
laying the sound-absorbing felt in piles to form upper felt layers and lower felt layers; and
sequentially layering the lower felt layers, the filler, and the upper felt layers in piles and applying heat and pressure thereto to fabricate a convergence sound-absorbing material.

8. The method of claim 7, wherein the sound-absorbing felt is formed by mixing the LM point PET fiber and the regular PET fiber at a weight ratio of about (25-45):(55-75).

9. The method of claim 7, wherein the filler is formed by mixing the LM point PET fiber, the regular PET fiber, and the chip foam at a weight ratio of about (25-45):(15-35):(30-50).

10. The method of claim 7, wherein in the convergence sound-absorbing material, the upper layers and the lower layers each have a weight per area of about 200-800 g/m² and the intermediate layer has a weight per area of about 1500-1900 g/m².

11. The method of claim 7, wherein in each fabrication step of the convergence sound-absorbing material, the melting temperature and heat applied are about 150-180° C.

12. The method of claim 7, further comprising grinding waste sound-absorbing pieces from cut sound-absorbing material to recycle the waste sound-absorbing pieces for use as a regular PET fiber substitute for the filler.
